(19) United States
(12) Patent Application Publication
(10) Pub. No.: US 2011/0167180 A1
(43) Pub. Date: Jul. 7, 2011

(54) ANTENNA DOCKING STATION

(75) Inventors: Timothy Towell, Sherwood, OR (US); John Saw, Sammamish, WA (US)

(73) Assignee: Clear Wireless LLC, Kirkland, WA (US)

(21) Appl. No.: 12/683,361

(22) Filed: Jan. 6, 2010

(51) Int. Cl. G06F 13/38; H04B 1/40

(52) U.S. Cl. 710/62; 455/90.3

(57) ABSTRACT

A mechanical and electrical attachment apparatus for coupling a wireless communication device to a computing device such that higher levels of radiated power may be applied while maintaining adherence to FCC regulations. The attachment device includes apparatus for coupling the wireless device to the attachment device by establishing a plurality of electrical connections including a radio frequency signal connection. The apparatus also includes an antenna that is used to transmit and receive radio frequency signals. The apparatus may optionally include an RF amplifier.

### BACKGROUND OF THE INVENTION

1. Field of the Invention

The present invention is directed generally to a wireless device docking station including an antenna internal to the docking station.

2. Description of the Related Art

FCC regulations for wireless communication devices include categories such as “mobile” and “portable.” Each category specifies a certain specific absorption rate (SAR) of radio frequency (RF) radiation that may be imposed on persons near the device during its operation. The “portable” designation includes devices that will operate within 20 centimeters of the body of a user of the device. Such “portable” devices must also adhere to certain total radiated power requirements. Devices in the “mobile” category, on the other hand, must operate more than 20 centimeters away from the body of a user. This category also permits higher radiated power. The higher radiated power of the “mobile” category typically features a better signal-to-noise ratio thereby permitting more effective operation in noisy environments or at greater distances from the destination transceiver.

Conventional wireless communication devices that are used in conjunction with a personal computer are typically integrated into the computer itself, or plug directly into the computer using, for example, a Universal Serial Bus (USB) interface. Because such USB wireless communication devices may be used with a laptop computer, and therefore operate within 20 centimeters of the user of the laptop, these types of devices must generally adhere to the “portable” regulation limits.

Unfortunately, using integrated devices and USB plug-in devices limit the total power that may be radiated by the wireless communication device thus limiting its effectiveness in environments with a lot of ambient RF noise or where the device is located at some distance from its associated receiver. There is therefore a need for a device that would permit “portable” wireless communication devices to operate with higher power and/or sensitivity.

### BRIEF DESCRIPTION OF THE SEVERAL VIEWS OF THE DRAWING(S)

FIG. 1 is a depiction of a laptop computer attached to a wireless communication device docking station according to an embodiment of the present disclosure.

FIG. 2 depicts a wireless communication docking device according to one embodiment of the present disclosure.

FIGS. 3-5 depict a docking sequence for the docking a wireless communication device with the second embodiment of the docking device as depicted in FIG. 2.

FIGS. 6 and 7 depict alternative means for mechanically engaging a wireless communication device with the docking station of the embodiment depicted in FIG. 2.

FIG. 10 is a block diagram of a wireless communication device docking system according to an embodiment of the present disclosure.

FIG. 11 is a perspective view of the docking station in accordance with an alternative embodiment.

FIG. 12 is a perspective view of the docking station of FIG. 11 with a replacement front panel cover.

FIGS. 13-15 illustrate yet another alternative embodiment of the docking station with certain portions removed to illustrate internal structural features of the docking station.

### DETAILED DESCRIPTION OF THE INVENTION

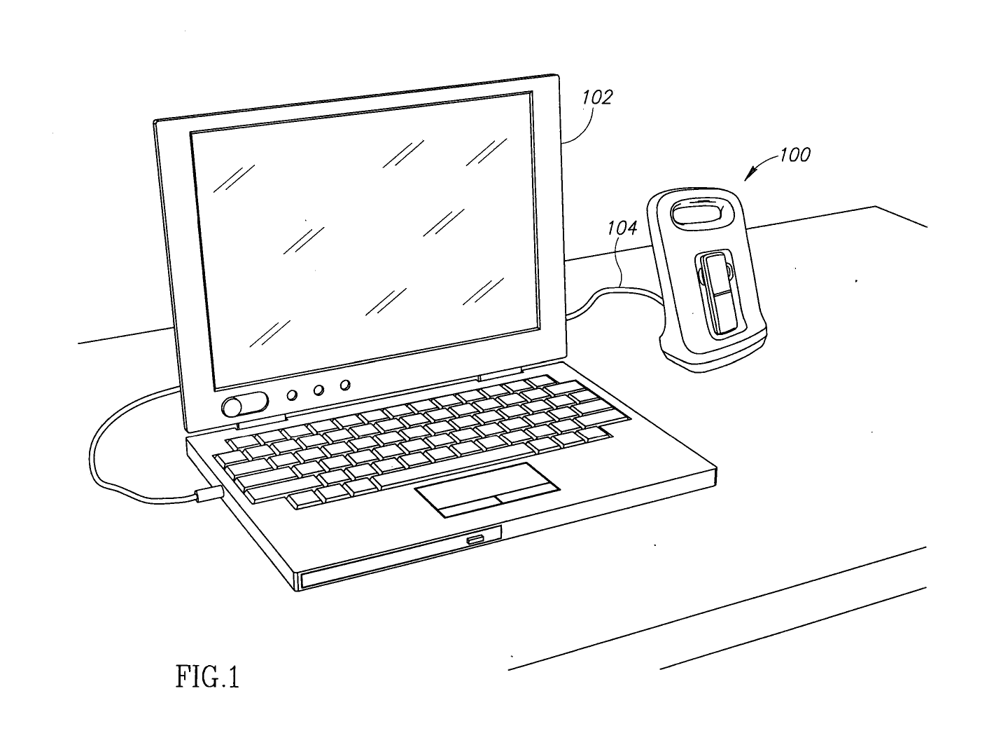

FIG. 1 depicts a computing device 102, such as a laptop computer, attached to a wireless communication device docking station 100 according to an embodiment. The docking station 100 may connect to the computing device 102 through, for example, a USB cable 104. Other wire or cable-based interfaces, such as Ethernet, Firewire, IEEE 488, and the like, are also within the scope of the present disclosure. Likewise, the scope of the present disclosure includes wireless interfaces such as, for example, IEEE 802.11, Bluetooth, optical connections, and the like. Embodiments of the docking station 100 will now be discussed in more detail.

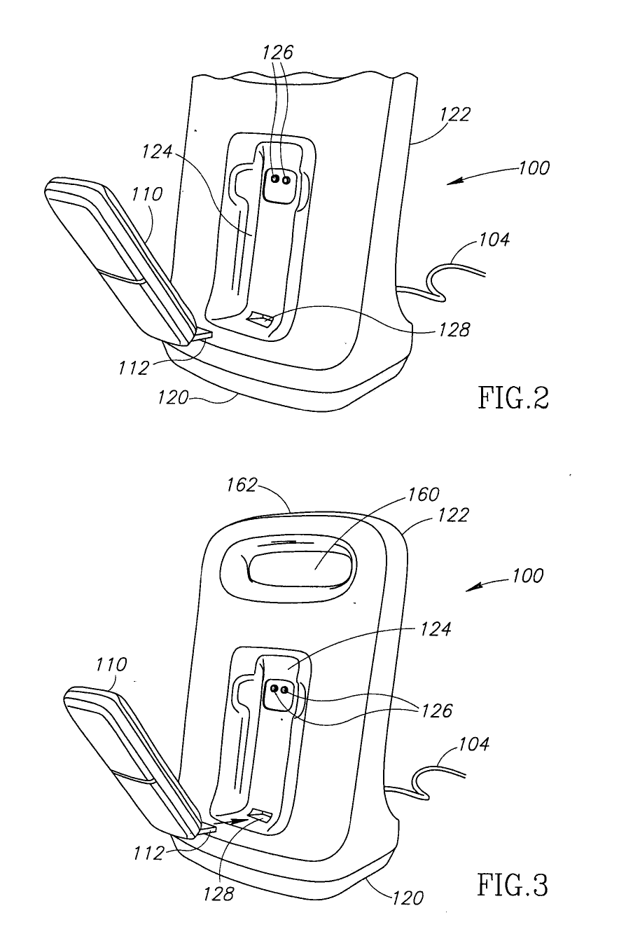

The examples presented herein illustrate the docking station 100 adapted to receive and retain a conventional wireless device 110, such as a radio frequency (RF) adapter shown in FIG. 2, designed to plug into a USB port of a computing device. In the examples illustrated herein, the wireless device 110 has a USB connector 112. Those skilled in the art will appreciate that the wireless device 110 would have a different connector if implemented using a different interface, such as a Firewire connection.

FIG. 2 depicts the docking station 100 according to one embodiment. The docking station 100 includes a base 120, a body 122, and a docking cradle 124. The docking station 100 is coupled to an external computing device (e.g. the computing device 102 of FIG. 1) via the cable 104. The docking station 100 includes RF connector ports 126 in the rear wall of the docking cradle 124, and a USB connector 128 as is described in greater detail below.

The electrical and mechanical coupling of the wireless device 110 to the docking station 100 will now be described with reference to FIGS. 2-5.

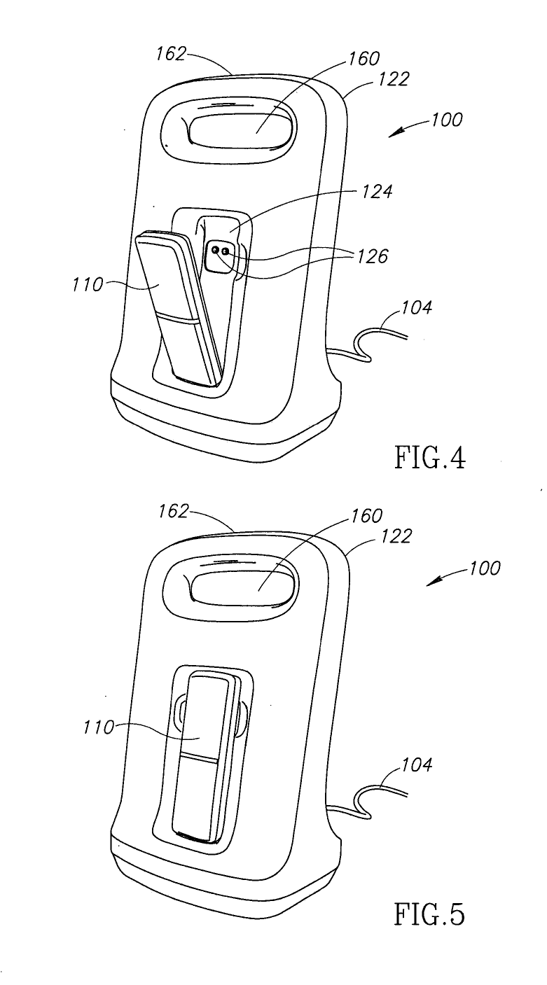

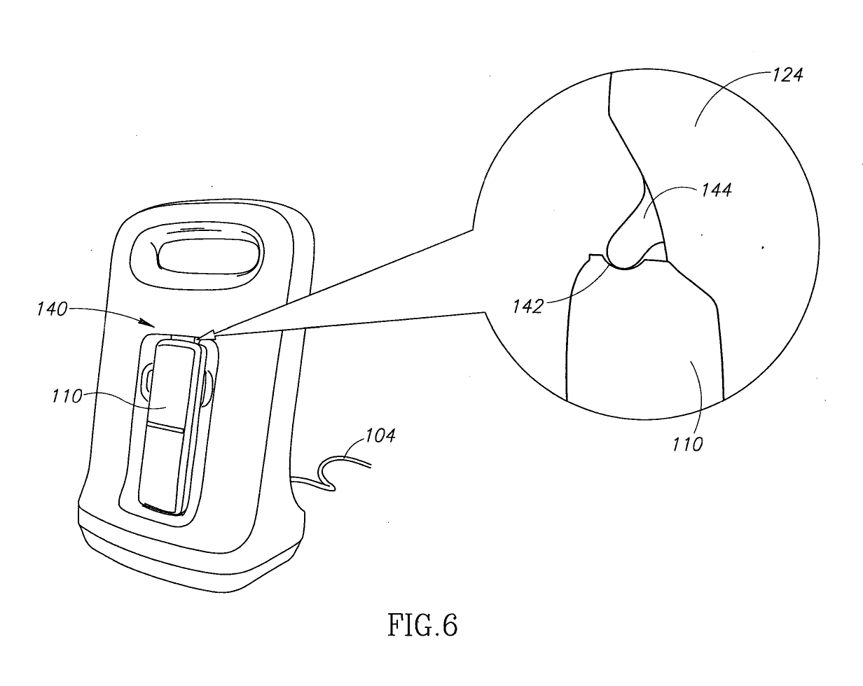

The USB connector 112 of the wireless device 110 is rotatably connected to the wireless device such that the wireless device may pivot up and down relative to the USB connector. The wireless device 110 may be connected to the docking station 100 by first inserting the USB connector 112 of the wireless device 110 into the mating USB connector 128 of the docking station 100, as shown in FIGS. 2 and 3. Once the USB connection is established, the wireless device 110 may be pivoted, as shown in FIG. 4, into its final position as shown in FIG. 5.

Alternatively, the USB connector 128 (or other connector type) of the docking station 100 may be pivotally mounted to the docking station at the bottom of the docking cradle 124. In this embodiment, the USB connector 128 may swing outward slightly from the docking station 100 to permit the connection of the USB connector 112 of the wireless device 110. Once the connection is made, the user presses the wireless device 110 into the cradle 124. As the wireless device 110 is pressed into position within the cradle 124, the USB connector 128 on the docking station 100 swivels to maintain its connection with the USB connector 112 on the wireless device 110.

Although the mechanical coupling of the wireless device 110 to the docking station 100 may rely entirely on the mechanical retention provided by the USB connectors 112 and 128, the docking station 100 may supplement this retention by other means. For example, the docking cradle 124 may be sized to engage with and frictionally retain the wireless device 110.

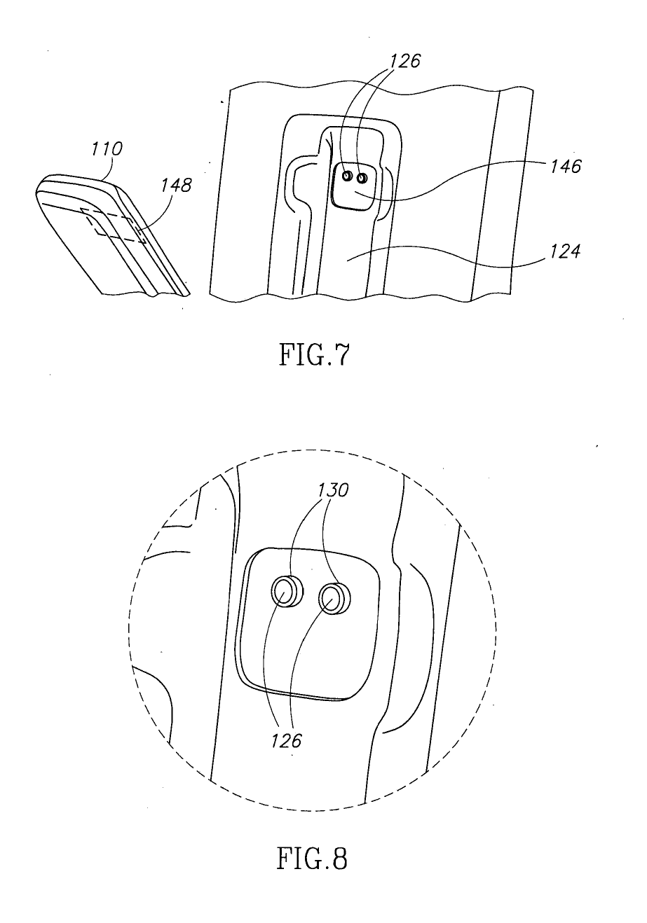

Alternative means for mechanical retention of the wireless device 110 within the docking cradle 124 are depicted in FIGS. 6 and 7, as described below. FIG. 6 depicts a mechanical retention mechanism 140 for holding the wireless device 110 within the docking cradle 124. A single recess 142 may be formed in the topmost portion of the wireless device 110. A corresponding finger 144 is positioned in the upper portion of the docking cradle 124 to mate and engage with the recess 142 and thereby mechanically secure the wireless device 110 to the docking cradle 124. Alternatively, one or more recesses and corresponding fingers (not shown) me be positioned along the sides of the wireless device 110 and docking cradle 124.

FIG. 7 shows yet another alternative means of mechanically retaining a wireless device 110 within the docking cradle 124. Instead of recesses 142 and fingers 144, a magnet 146 may be placed in a rearmost portion of the docking cradle 124 so as to attract a corresponding magnet or ferrous material 148 placed within the wireless device 110.

In addition to the mechanical engagement of the wireless device 110 to the docking station 100, the docking cradle 124 also provides an electrical connection between the docking station 100 and the wireless device 110. The connection between the USB connector 112 on the wireless device 110 and the mating USB connector 128 on the docking station 100 provides both an electrical and a mechanical connection between the wireless device and the docking station. In addition, as previously noted, the RF connector ports 126 are positioned in the rear wall of the docking cradle 124, as illustrated in FIGS. 2-4 and FIG. 7. The wireless device 110 includes a pair of corresponding RF connection points 132 (see FIG. 9) that connect with the docking station 100 when the wireless device is inserted into the docking cradle 124.

FIGS. 8 and 9 depict electrically conductive RF signal pins 130 and the RF connector ports 126 of the docking station 100 in more detail. FIG. 8 shows the docking cradle 124 without the wireless device 110 in place to show the RF signal pins 130 more clearly. The RF signal pins 130 are mounted to the body 122 and extend through the RF connector ports 126 on the docking cradle 124 to make electrical contact with corresponding RF connection points 132 (see FIG. 9) on the wireless device 110 when the wireless device is in the retention position within the docking cradle 124. When the wireless device 110 is in the insertion position (see FIG. 4), the RF pins 130 are withdrawn from the RF connector ports 126 to allow the wireless device 110 to pivot outward for insertion and/or removal.

In one embodiment, the RF signal pins 130 may be resiliently attached to the body 122 by springs or other resilient members such that the RF signal pins are urged forward into electrical contact with corresponding RF connector points 132 on the wireless device 110, as shown in FIG. 9. Springs or similar elements may be used to help urge the RF signal pins 130 into contact with the wireless device 110.

As illustrated in FIG. 8, the RF signal pins 130 are in physical contact with the RF connector ports 126 when the wireless device 110 is in the retention position within the docking cradle 124. In this embodiment, the RF connector ports 126 are also electrically conductive. When the wireless device 110 is in the retention position within the docking cradle 124, both the RF connector ports 126 and the RF signal pins 130 make electrical connections with the wireless device 110. Alternatively, the RF connector ports 126 may simply be one or more apertures through the rear wall of the docking cradle 124 to permit the RF signal pins 130 to pass through without any electrical connection between the RF signal pins in the RF connector ports. Alternatively, the RF connector ports 126 may simply be one or more apertures through the rear wall of the docking cradle 124 to permit the RF signal pins 130 to pass through without any physical or electrical connection between the RF signal pins in the RF connector ports.

Returning again to FIGS. 3-5, the process of inserting the wireless device 110 into the docking cradle 124 also establishes an electrical connection between the RF connector points 132 (see FIG. 9) on the wireless device 110 and the RF signal pins 130 and/or the RF connector ports 126 in the docking cradle 124 of the docking station 100. As illustrated in FIGS. 3-4, the mechanical and electrical connection is established between the USB connector 112 on the wireless device 110 and the mating USB connector 128 in the docking cradle 124 of the docking station 100. As the wireless device 110 is rotated into the insertion position, illustrated in FIG. 5, the electrical connection is established between the RF signal pins 130 of the docking station 100 and the RF connection points 132 on the wireless device 110.

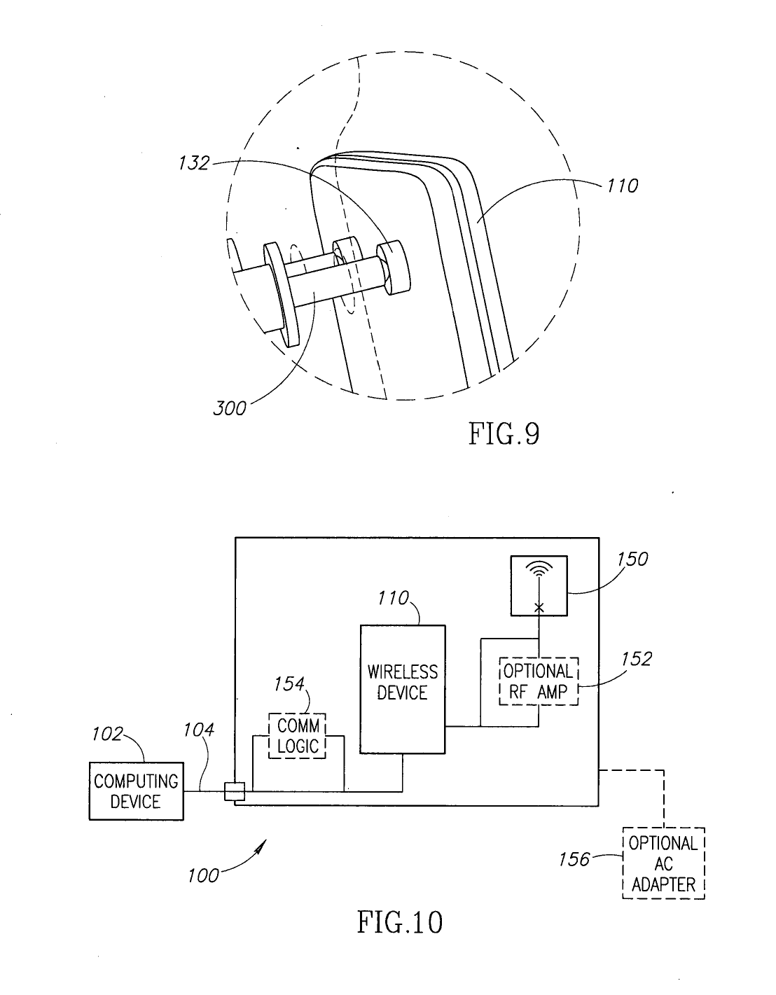

FIG. 10 is a block diagram of the docking station 100 according to an exemplary embodiment. The docking station 100 is coupled to the computing device 102. The wireless device 110 is mechanically and electrically coupled to the docking cradle 124 in a manner described above. Contained within the docking station 100 is an antenna 150. The docking station 100 may also optionally include an amplifier 152, communication logic 154 and/or an external AC power adapter 156. The addition of the antenna 150 and optional RF amplifier 152 provide greater signal strength, as described in greater detail below.

The wireless device 110 may be, for example, a cellular telephone, a wireless USB modem or other wireless device. When the wireless device 110 is present in the docking station 100, the wireless device is electrically coupled to the docking station in at least two ways.

First, the wireless device 110 is coupled to the computing device 102 via the docking station 100. The electrical coupling to the may be accomplished in a number of ways such as, for example, via the USB cable 104 as described above. However, other means of connection and communication are possible. For example, the docking station 100 may be coupled to the computing device 102 via a wired or wireless network connection such as Ethernet or with an optical or infrared communication link. Such a configuration would typically require the communication logic 154 for managing the communication protocols and/or translating the information between various formats.

Second, the wireless device 110 is coupled to the docking station 100 via suitable RF connectors (e.g., the RF connector ports 126, the RF signal pins 130, and the RF connection points 132) that pass the transmitted radio frequency energy from the wireless device 110 to the docking station 100. This RF energy may be passed directly to the antenna 150 to radiate the RF energy to the receiving station. The antenna 150 may be virtually any form of antenna or multiple antennas as is known in the art. For example, the antenna 150 may be any of a fractional wavelength dipole, a slotted or other type of waveguide, a multiple element yagi, or other suitable antenna as is known in the art. The use of a high gain antenna may be advantageous in certain embodiments because such an antenna typically improves the signal-to-noise ratio without requiring a higher transmitter power. Maintaining low transmitter power may be desirable in order to conserve power in the docking station 100 itself and for overall power management in a communication system. Likewise, some embodiments of the invention may use multiple antennas such as multiple input-multiple output (MIMO) antennas as is likewise known in the art.

The RF energy passed from the wireless device 110 may optionally be amplified by the RF amplifier 152. This permits the radiated signal to have much higher transmit power than would be permitted if the wireless device 110 were operating in accordance with the power limitations of the “portable” category and thereby increasing the signal-to-noise ratio as described above. One of ordinary skill will appreciate that certain other embodiments may use both a high gain antenna in conjunction with the RF amplifier 152.

As will be understood by one of ordinary skill, the antenna 150 likewise serves the function of receiving RF signals and passing them to the receiver of the wireless device 110. If the RF amplifier 152 is included, it may serve as a form of preamplifier for the receiver of the wireless device 110.

The wireless device 110 and the communication logic 154 and RF amplifier 152, if present, may all derive power from the computing device 102 in certain embodiments. For example, if the docking station 100 is connected to the computing device 102 via the USB cable 104, electrical power may be provided by the computing device 102 via the USB cable. Those skilled in the art will appreciate the USB standards provide for relatively low current output. If the docking station 100 is connected to the computing device 102 in some other manner, or if the power requirements of the docking station 100 exceed the power that the computing device 102 is capable of providing via the USB cable 104, it may be necessary to use the external AC adapter 156 or other power source for providing power to the components of the docking system 700. Those skilled in the art will appreciate that the docking station 100 may be implemented in a form to accommodate various communications standards, such as GSM, CDMA, WCDMA, WiMAX, and the like. The elements described herein, such as the antenna 150 and the RF amplifier 152 are designed to meet the operational requirements of the selected communication standard. The docking station 100 is not limited to any particular form of wideband wireless network communication.

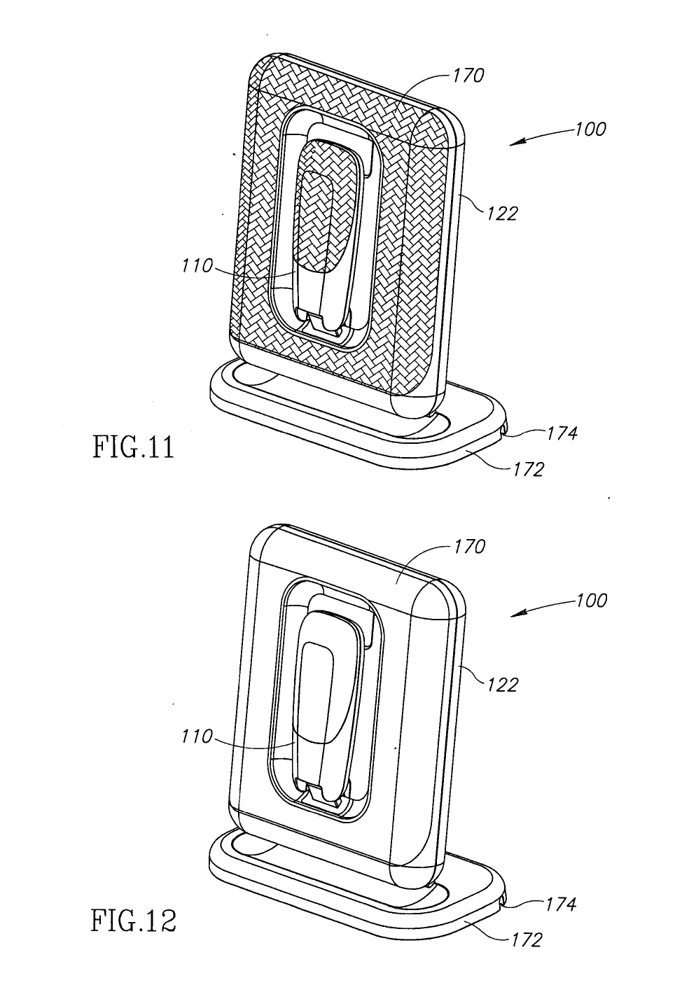

Those skilled in the art will also appreciate that the docking station 100 may be implemented in a variety of packaging options. For example, the embodiment of FIGS. 3-6 illustrates an aperture 160 in the docking station 100 to conveniently form a handle 162. The handle 162 may be used to carry the docking station 100 or to position it for optimal signal quality. Alternatively, FIG. 11 illustrates the docking station 100 with an interchangeable front panel 170 mounted to a base 172. The base 172 may include one or more cutouts 174 used for cable management. As illustrated in FIG. 11, the cutout 174 is provided on the right side portion of the base 172. In addition, the base 172 may include cutouts 174 (not shown) in the back portion of the base and on the left side of the base to allow greater flexibility in positioning the cable 104 (see FIG. 1).

FIG. 12 illustrates the docking station 100 with a different design for the front panel 170. This may conveniently allow the user to select from a variety of color and/or texture options for the front panel 170.

In yet another embodiment, the docking station 100 may be detachably coupled to the base 172. In this option, the docking station 100 may include one or more suction cups (not shown) coupled to the back of the docking station. This may conveniently allow the docking station to be attached, via the suction cups, to a window to permit improved reception. In yet another alternative, the suction cups (not shown) may be coupled to a mounting bracket (not shown) that attaches to the back of the docking station 100. In this embodiment, the docking station 100 may be supported in a window-mount configuration by hooks or tabs (not shown) projecting from the back of the docking station 100 that hang on the brackets coupled to the window via the suction cups. This may conveniently allow the docking station 100 to be moved simply by removing it form the brackets.

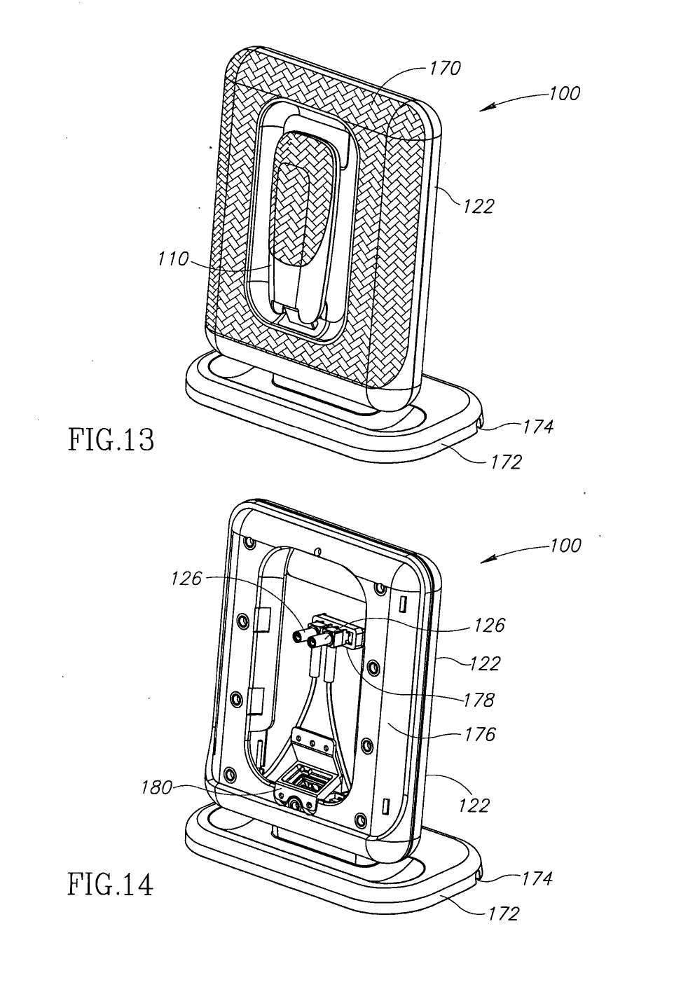

FIGS. 13-15 illustrate yet another embodiment of the docking station 100 as well as illustrating the mounting of certain internal components. As illustrated in FIGS. 11-12, the front panel 170 may be interchangeable. FIG. 13 illustrates the docking station 100 with the selected front panel 170 from FIG. 11.

In FIG. 14, the front panel 170 has been removed to expose a protective cover 176. This better illustrates the RF connector ports 126, which are coupled to the docking station 100 via a connector mounting bracket 178.

Also illustrated in FIG. 14 is a USB mounting bracket 180. As discussed above, the wireless device 110, in one embodiment, is coupled to the docking station 100 via a USB connector (e.g., the USB connector 112 on the wireless device 110 and the mating USB connector 128 on the docking station 100). In one embodiment, the USB connector 112 on the wireless device 110 rotates as the wireless device is inserted into the docking station 100, in the manner illustrated in FIGS. 3-5. Alternatively, the USB mounting bracket 180 may be rotatably coupled to the docking station 100 so that it can swivel outward to receive the wireless device 110.

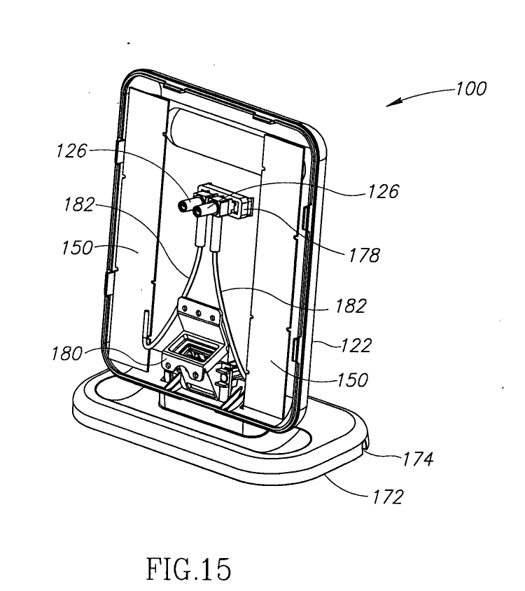

In FIG. 15, the protective cover 176 has been removed to further illustrate structural details of the docking station 100. The antenna 150 is illustrated in FIG. 15. The RF connector ports 126 are coupled to the antenna 150 via antenna cables 182. In an exemplary embodiment, the antenna 150 comprises two antenna elements of a MIMO antenna. MIMO antenna design is well known in the art and need not be described in greater detail herein. However, the size and relative positioning of the elements in the antenna 150 are configured for optimal operation at the selected radio frequencies. Those skilled in the art will recognize that other antenna designed may be used to implement the antenna 150. The docking station 100 is not limited by the specific implementation of the antenna 150.

In the embodiment illustrated in FIGS. 13-15, the docking station 100 may be removably coupled to the base 172. As previously discussed, the docking station 100 may include one or more suction cups (not shown) to permit the docking station to be mounted to a surface, such as a window, for improved reception. Alternatively, the suction cups (not shown) may be coupled to a mounting bracket (not shown). In turn, the docking station 100 may be removably attached to the brackets such that the brackets and suction cups may remain attached to the window. The docking station 100 is simply hung on the brackets when desired.

Those skilled in the art will appreciate that other implementations and structural variations of the docking station may be employed utilizing the teachings contained herein. The docking station is not limited to the specific mechanical implementations illustrated herein.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. An apparatus for coupling a radio frequency (RF) transceiver to an electrical device comprising:
a housing;
a receiving chamber coupled to the housing;
an interface configured for communication with the electrical device;
a connector coupled to the interface and configured to be coupled to the RF transceiver when the RF transceiver is disposed within the receiving chamber, thereby electrically coupling the RF transceiver to the electrical device and permitting communication therebetween;
a signal coupler configured to form an electrical connection with a RF coupler disposed on the RF transceiver when the RF transceiver is placed within the receiving chamber, thereby electrically coupling RF signals between the RF transceiver and the attachment apparatus; and
an antenna coupled to the signal coupler.

2. The apparatus of claim 1 wherein the receiving chamber comprises a recess in the housing wherein the signal coupler and the electrical connector are disposed, the electrical connector configured to connect to the RF transceiver when a first end of the RF transceiver is inserted into the recess, the first end of the RF transceiver being rotatably coupled to a second end of the RF transceiver to permit the second end to pivot into the recess, the RF coupler being disposed on the RF transceiver in a predetermined location so as to connect with the signal coupler when the RF transceiver is pivoted into the recess thereby electrically coupling the RF signals between the RF transceiver and the apparatus.

3. The apparatus of claim 2 wherein the recess includes a magnet configured to attract a corresponding magnet or ferrous object within the RF transceiver to retain the mechanical coupling of the RF transceiver by magnetic attraction when the RF transceiver is disposed within the recess.

4. The apparatus of claim 2 wherein the recess further comprises a pawl configured to resiliently couple with a detent formed on a surface of the RF transceiver when the RF transceiver is disposed within the recess and thereby retaining the mechanical coupling between the RF transceiver and the apparatus.

5. The apparatus of claim 1 further comprising an RF amplifier coupled between the signal coupler and the antenna and configured to amplify RF signals transmitted or received by the antenna.

6. The apparatus of claim 5, further comprising an external power source configured to provide electrical power to the apparatus.

7. The apparatus of claim 5 wherein the connector is further configured to provide electrical power to the apparatus.

8. The apparatus of claim 1 wherein the connector comprises a USB connector.

9. The apparatus of claim 1 wherein the electrical device comprises a computer.

10. The apparatus of claim 1 wherein the apparatus is coupled to the electrical device to permit a separation distance of at least 20 centimeters between the apparatus and nearby persons.

11. A docking apparatus configured to connect to a computer comprising:
receiving means configured to accept the RF transceiver;
a first connector disposed within the receiving means and configured to electrically couple the RF transceiver to the computer when the RF transceiver is disposed within the receiving means;
a second connector disposed within the receiving means and configured to couple RF signals between the RF transceiver and the docking apparatus when the RF transceiver is disposed within receiving means; and
an antenna coupled to the second connector.

12. The docking apparatus of claim 11 wherein the receiving means comprises a recess having first and second ends with the first connector being disposed at the receiving means first end and configured to connect to the RF transceiver when a first end of the RF transceiver is inserted into the recess, the first end of the RF transceiver being rotatably coupled to a second end of the RF transceiver to permit the second end to pivot into the receiving means when the first end of the RF transceiver is inserted into the recess.

13. The docking apparatus of claim 12 wherein the receiving means includes a magnet configured to attract a corresponding magnet or ferrous object within the RF transceiver to retain the mechanical coupling of the RF transceiver by magnetic attraction when the RF transceiver is disposed within the recess.

14. The docking apparatus of claim 12 wherein the receiving means of the RF transceiver docking station further comprises a pawl configured to resiliently couple with a detent formed on a surface of the RF transceiver when the RF transceiver is disposed within the receiving means thereby retaining the mechanical coupling between the RF transceiver and the RF transceiver docking apparatus.

15. The docking apparatus of claim 11 further comprises an amplifier coupled between the second connector and the antenna and configured to amplify RF signals transmitted on the antenna.

16. The docking apparatus of claim 15 further comprising a power supply configured to provide electrical power to the RF transceiver, the RF amplifier, or both.

17. The docking apparatus of claim 15 wherein the docking apparatus is configured to provide electrical power from the computer to the RF transceiver, the RF amplifier, or both.

18. The docking apparatus of claim 11 wherein the first connector comprises a USB connector.

19. The docking apparatus of claim 11 wherein the RF transceiver docking apparatus is configured to be coupled to the computer to permit a separation distance of at least 20 centimeters from nearby persons.

20. The apparatus of claim 11, further comprising a housing wherein the receiving means is coupled to the housing, and a base coupled to the housing.

21. The apparatus of claim 20 where in the housing is removably coupled to the base.
